(19) United States
(12) Patent Application Publication
(10) Pub. No.: US 2025/0218706 A1
(43) Pub. Date: Jul. 3, 2025

(54) SWITCH STRUCTURE ELECTRICALLY LINKED WITH A LIGHT SOURCE

(71) Applicants: SWITCHLAB INC., NEW TAIPEI CITY (TW); SWITCHLAB (SHANGHAI) CO., LTD., SHANGHAI CITY (CN); GAOCHENG ELECTRONICS CO., LTD., GUANGDONG PROVINCE (CN)

(72) Inventors: CHIH-YUAN WU, NEW TAIPEI CITY (TW); WEN BING HSU, NEW TAIPEI CITY (TW)

(21) Appl. No.: 18/944,336

(22) Filed: Nov. 12, 2024

(30) Foreign Application Priority Data
Dec. 29, 2023 (TW) 112151592

(51) Int. Cl. H01H 13/14; H01H 13/04

(52) U.S. Cl. CPC H01H 13/14; H01H 13/04

(57) ABSTRACT

A switch structure electrically linked with a light source includes a main body, a push button assembly, and at least one contact block. The main body includes a base and an internal switch assembly. The base is provided with a plurality of power terminals for connecting to an external power source and the internal switch assembly is serially connected to between the power terminals and a light source. The contact block includes a plurality of control terminals for connecting to external devices to be controlled; and the push button assembly can drive the internal switch assembly and the contact block, so that the control terminals of the contact block are electrically connected to each other and the light source is synchronously controlled by the internal switch assembly to electrically connect to the external power source and emit light, which can indicate an operational state of the switch structure.

### FIELD OF THE INVENTION

The present invention relates to a switch structure electrically linked with a light source, and more particularly, to a switch structure that is provided with an internal switch assembly for independently controlling a light source to operate without occupying any control contact for connecting to a external device to be controlled. Therefore, the switch structure can have simplified wiring, increased scope of application, and upgraded operational efficiency.

### BACKGROUND OF THE INVENTION

When using a conventional small and simple type control switch, there are often factors to be taken into consideration, such as cost and available space. Therefore, it is impossible to synchronously indicate the operational movement and the operational state of the switch by using an expensive programmable logic controller (PLC) or other external switch controlled light source. If it is necessary to synchronously indicate the switch operational movement or operational state with a light source, one of the control contacts on the switch that is originally intended for connecting to an external device to be controlled must be occupied exclusively by the light source to enable the synchronous indication of the switch operational state.

FIG. 1 shows a commonly seen switch device that includes one single push button for manipulating a plurality of contact blocks assembled to each other. The switch device in FIG. 1 includes a single coupling seat 40, which provides a space for coupling three contact blocks 5 thereto. Each of the contact blocks 5 is provided with at least one control terminal 51 for connecting with an external device to be controlled. The contact blocks 5 are controllable by one push button assembly 20 to operate synchronously, so as to control the external devices to operate. In the case light sources (or light emitting mechanisms) are needed to indicate the operational movement and operational state of the switch device, a light holder 10 with a light source (not shown) is required to replace one of the contact blocks 5. Further, the light holder 10 only provides a relatively simple fixing structure for holding the light source. That is, the light holder 10 only has an electrical contact 101 provided on a surface thereof for connecting to the light source, and there is not any other control structure provided in the light holder 10 for making the light source.

In practical application of the conventional switch device, the control terminal 51 on one of the remaining contact blocks 5 is serially electrically connected to the electrical contact 101 of the light holder 10 before being connected to an external power source. When the push button assembly 20 is pushed to control the contact blocks 5, the light source on the light holder 10 is electrically made at the same time to emit light for indicating the operational movement and operational state of the switch device. With these arrangements, the quantity of the contact blocks that can be used by the switch device to control the external devices is decreased, and the practical application efficiency of the switch device is also reduced. Further, the electrical connection between the control terminals 51 on the contact blocks 5 and the electrical contact 101 on the light holder 10 not only influences the internal structural design of the switch device, but also makes the wiring of the switch device more complicated.

In view of the above shortcomings in the light source control mechanism of the conventional small and simple type switch, it is tried by the inventor to develop a switch structure electrically linked with a light source in an attempt to overcome the disadvantages of the conventional switch device.

### SUMMARY OF THE INVENTION

A primary object of the present invention is to provide a switch structure electrically linked with a light source, which includes a main body, a push button assembly, and at least one contact block. The main body includes a base provided with a plurality of power terminals for connecting to an external power source, and an internal switch assembly being serially connected to between the power terminals and a light source. The contact block includes a plurality of control terminals for connecting to an external device to be controlled. The push button assembly is able to drive the internal switch assembly and the contact block, such that the contact block changes an electrical connection state between the control terminals and the internal switch assembly can synchronously control the light source to electrically connect to the external power source. Since the above arrangement does not occupy any contact block that is originally intended for connecting to the external device to be controlled, the switch structure can have overall upgraded usage effectiveness.

Another object of the present invention is to provide the above switch structure electrically linked with a light source, the internal switch assembly of which includes two fixedly spaced conducting section and an elastic conducting element (such as a torsion spring) located between the two conducting sections. The two conducting sections are electrically connected to the power terminals and the light source, respectively. The elastic conducting element is driven by the push button assembly to contact with the two conducting sections at the same time or separate from the two conducting sections at the same time, so as to control the connection or disconnection of the light source to or from the power source. With these arrangements, the switch structure can operate in a simple and accurate manner and have simplified internal wiring.

A further object of the present invention is to provide the above switch structure electrically linked with a light source, the push button assembly of which includes a push button and an actuator electrically connected to each other. The actuator can actuate a link member and the contact blocks synchronously to change the electrical connection state between the control terminals of the contact block, so as to control the external device to operate. The link member brings the elastic conducting element (torsion spring) of the internal switch assembly to move, enabling the light source to emit light in response to the electrical connection state of the contact block.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled perspective view of a conventional switch structure combining a plurality of contact blocks;

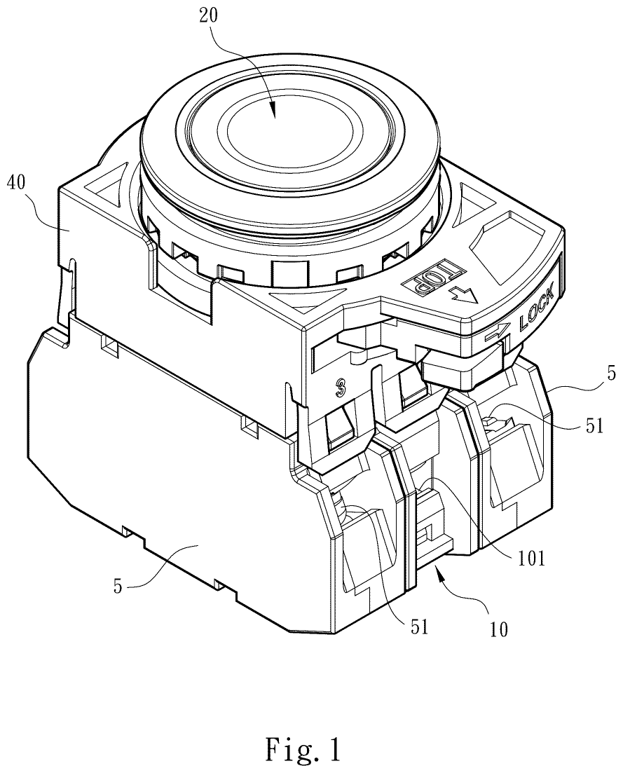

FIG. 2 is an exploded perspective view of a switch structure electrically linked with a light source according to a first embodiment of the present invention;

FIG. 3 is a fully exploded perspective view of a main body of the switch structure of FIG. 2;

FIG. 4 is an assembled perspective view of the switch structure according to the first embodiment of the present invention;

FIG. 5 is a vertical sectional view of the switch structure according to the first embodiment of the present invention;

FIG. 6 is a first sectional view showing the operation of the switch structure according to the first embodiment of the present invention, wherein all components of an internal switch assembly of the switch structure are in a natural position when a push button is not subjected to any force;

FIG. 7 is a second sectional view showing the operation of the switch structure according to the first embodiment of the present invention, wherein an elastic conducting element is in a partially deformed initial state when the push button is pushed down;

FIG. 8 is a third sectional view showing the operation of the switch structure according to the first embodiment of the present invention, wherein the elastic conducting element is in a fully deformed final state when the push button is pushed downward continuously;

FIG. 9 is a fully exploded perspective view of a main body of a switch structure according to a second embodiment of the present invention;

FIG. 10 is an assembled perspective view of the switch structure according to the second embodiment of the present invention;

FIG. 11 is a first sectional view showing the operation of the switch structure according to the second embodiment of the present invention, wherein all components of an internal switch assembly are in a natural position when a push button is not subjected to any force;

FIG. 12 is a second sectional view showing the operation of the switch structure according to the second embodiment of the present invention, wherein an elastic conducting element is in a partially deformed initial state when the push button is pushed down;

FIG. 13 is a third sectional view showing the operation of the switch structure according to the second embodiment of the present invention, wherein the elastic conducting element is in a fully deformed final state when the push button is pushed downward continuously;

FIG. 14 is an exploded perspective view of a main body of a switch structure according to a third embodiment of the present invention;

FIG. 15 is a first sectional view showing the operation of the switch structure according to the third embodiment of the present invention, wherein all components of an internal switch assembly are in a natural position when a push bottom is not subjected to any force; and

FIG. 16 is a second sectional view showing the operation of the switch structure according to the third embodiment of the present invention, wherein an elastic conducting element is in a partially deformed initial position when a push button is pushed down.

### DETAILED DESCRIPTION OF THE PREFERRED EMBODIMENTS

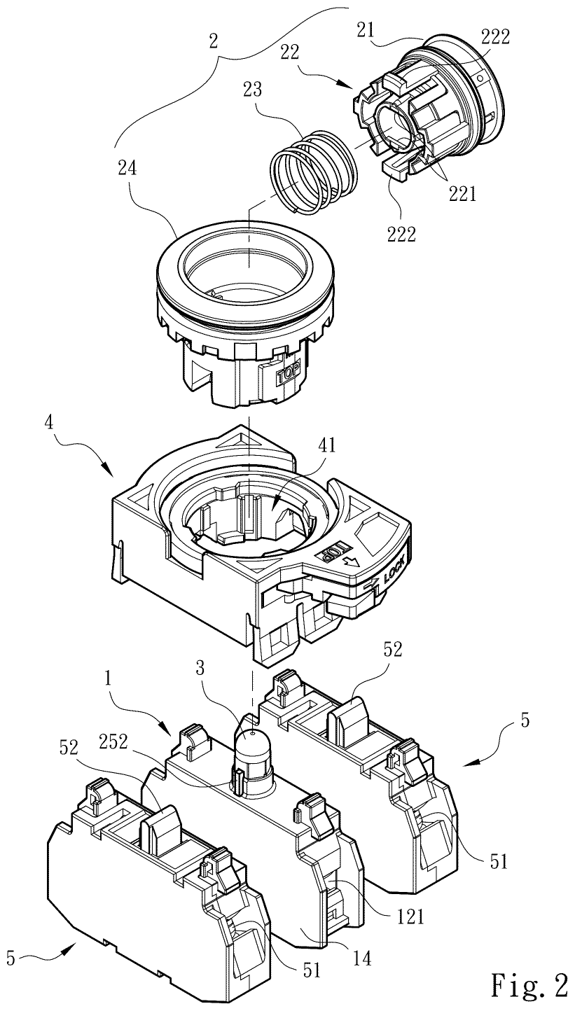

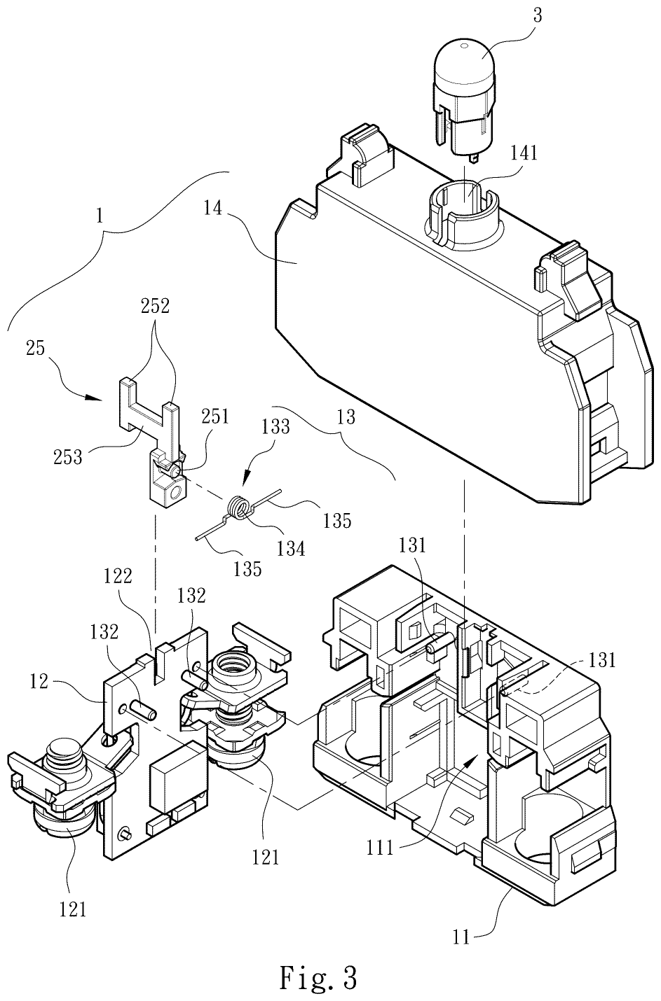

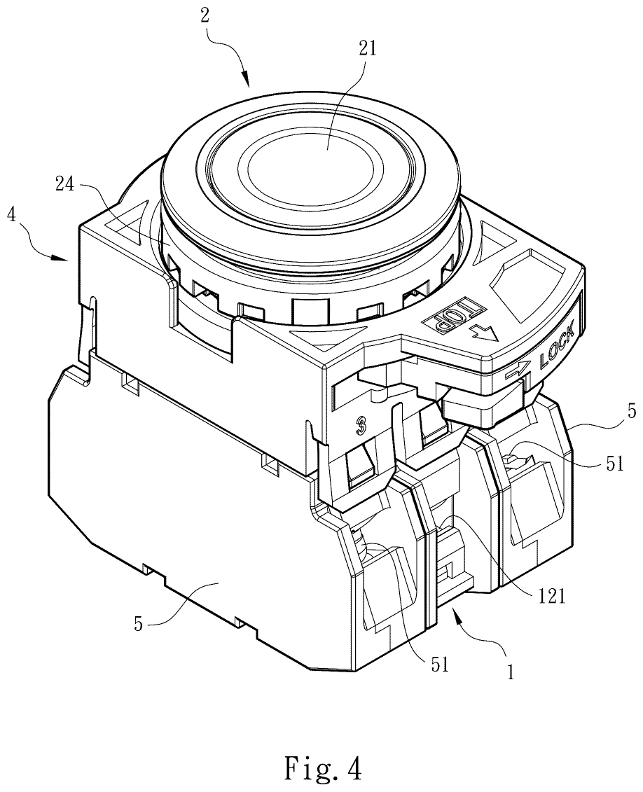

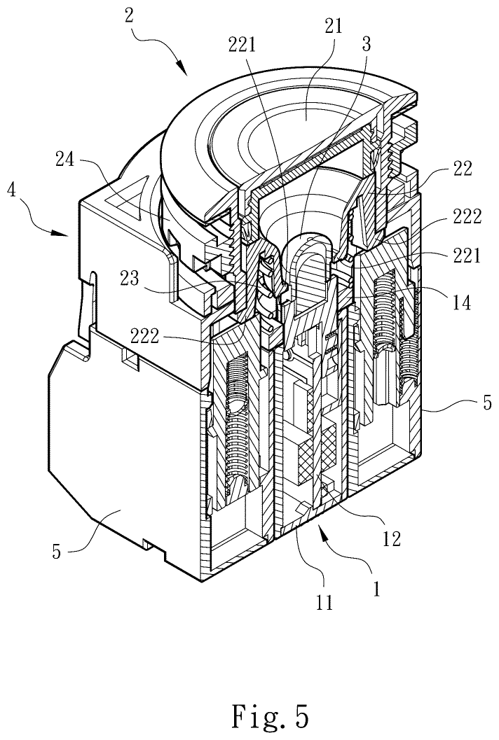

Please refer to FIGS. 2 to 6. A first embodiment of the present invention discloses a normally open switch structure, which includes a main body 1 having a substantially rectangular configuration and a push button assembly 2. The main body 1 includes a base 11 and an internal switch assembly 13. The base 11 internally defines a receiving space 111 for receiving a circuit board 12 therein. The circuit board 12 has a plurality of power terminals 121 provided thereon. In an operable embodiment, the base 11 can have a cover 14 externally fitted thereon, if necessary. The cover 14 is provided with an assembling hole 141, to which a light source 3 is fixedly mounted. The power terminals 121 are partially exposed from the cover 14 for a predetermined external power source to connect thereto.

The internal switch assembly 13 includes two post-like conducting sections 132 spaced from each other by a fixed distance and an elastic conducting element 133, such as a torsion spring, provided between the two post-like conducting sections 132. One of the two post-like conducting sections 132 is electrically connected to one of the power terminals 121, and the other post-like conducting section 132 is electrically connected to an end of the light source 3, such that the internal switch assembly 13 is serially connected to between the light source 3 and the power terminals 121. The elastic conducting element 133 has a middle portion formed into a cylindrical coil body 134, and two elastically bendable conducting arms 135 straightly or obliquely extended from two lateral sides or two ends of the cylindrical coil body 134 toward the two post-like conducting sections 132. The elastic conducting element 133 (i.e. the torsion spring) can be driven by the push button assembly 2 for the two conducting arms 135 to contact with or separate from the two post-like conducting sections 132, so as to control the light source 3 to ON or OFF.

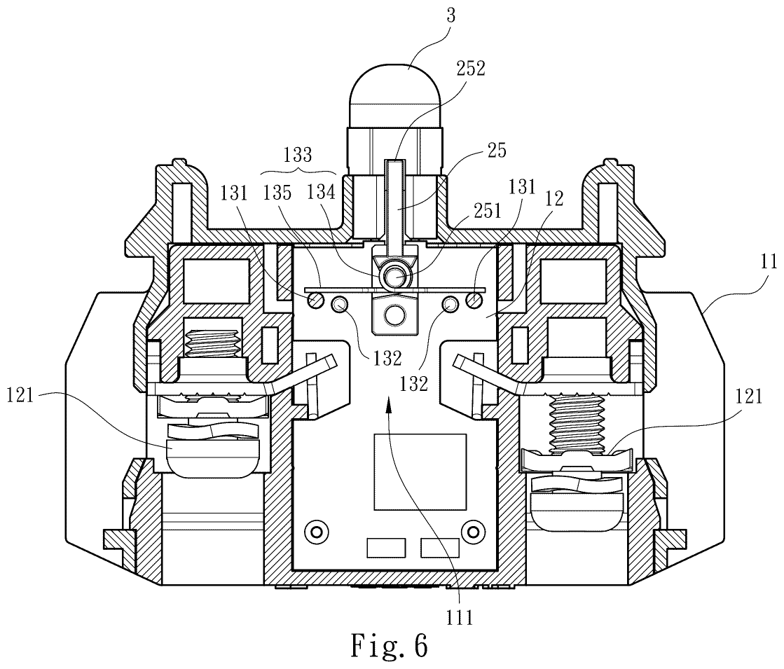

In the above structure, two post-like insulation stop sections 131 may be provided at two lateral outer sides of the two post-like conducting sections 132, if necessary. The insulation stop sections 131 are located in front of a moving path of the elastic conducting element 133. For example, as shown in FIG. 6, the two insulation stop sections 131 are respectively located at two lateral outer sides of the two conducting sections 132 and at a higher position than the conducting sections 132.

The push bottom assembly 2 includes a push button 21, an actuator 22, a push-bottom seat 24, and a link member 25. The push button 21 is a structure pervious to light. The push button 21 and the actuator 22 are received in the push-button seat 24, and the push-button seat 24 is mounted in a mounting hole 41 on a coupling seat 4. The coupling seat 4 is configured to parallelly connect and hold the main body 1 to at least one normally open contact block 5. The normally open contact block 5 has a substantially rectangular configuration and is provided with a plurality of control terminals 51, which are connectable to external devices to be controlled, and a push section 52 for controlling the control terminals 51 to an open or a closed circuit.

The actuator 22 has an end connected to the push button 21 and is accordingly, movable simultaneously with the push button 21. Another end of the actuator 22 is provided with first abutting sections 221 and second abutting sections 222 that are radially spaced from each other relative to a center of the actuator 22. The second abutting sections 222 can correspondingly abut against the push sections 52 of the normally open contact blocks 5. An elastic element 23 is fitted between the first and the second abutting sections 221, 222 to press against a top of the main body 1 (i.e. the cover 14), so that the actuator 22 together with the push button 21 has a degree of elasticity to maintain at a non-pushed position.

The link member 25 includes a coupling section 251 and at least one upward protruded section 252. The coupling section 251 is coupled with the cylindrical coil body 134 of the elastic conducting element 133, and the upward protruded section 252 is located corresponding to the first abutting sections 221.

In an operable embodiment, the two conducting sections 132 are provided on the circuit board 12, which is provided at a position between the two conducting sections 132 with a longitudinally extended guide slot 122. The insulation stop sections 131 are provided in the receiving space 111 of the base 11, such that the insulation stop sections 131 are just located at two lateral outer sides of the two conducting sections 132 after the circuit board 12 is assembled to the receiving space 11. The link member 25 further includes a sliding guide section 253, which is transversely extended between the coupling section 251 and the upward protruded section 252 to be located and slidable in the sliding guide slot 122, such that the link member 25 can bring the elastic conducting element 133 to move along a longitudinal path between the two conducting sections 132.

In the first embodiment, when the push button 21 is in a natural state without being downward pushed, the actuator 22 is supported by the elastic element 23 and located at a position spaced from the link member 25, and the link member 25 is not in contact with the push sections 52 of the normally open contact blocks 5. Therefore, the two control terminals 51 maintain at the electrically disconnected state, and the external device connected to the two control terminals 51 is in a disabled state. Meanwhile, the insulation stop sections 131 are abutted against the two straight conducting arms 135 of the elastic conducting elements 133, such that the two conducting sections 132 are in a pressure preloaded condition and could not contact with and electrically connect to the two conducting arms 135. Therefore, the light source 3 is not electrically connected to the external power source and could not emit light, as shown in FIG. 6.

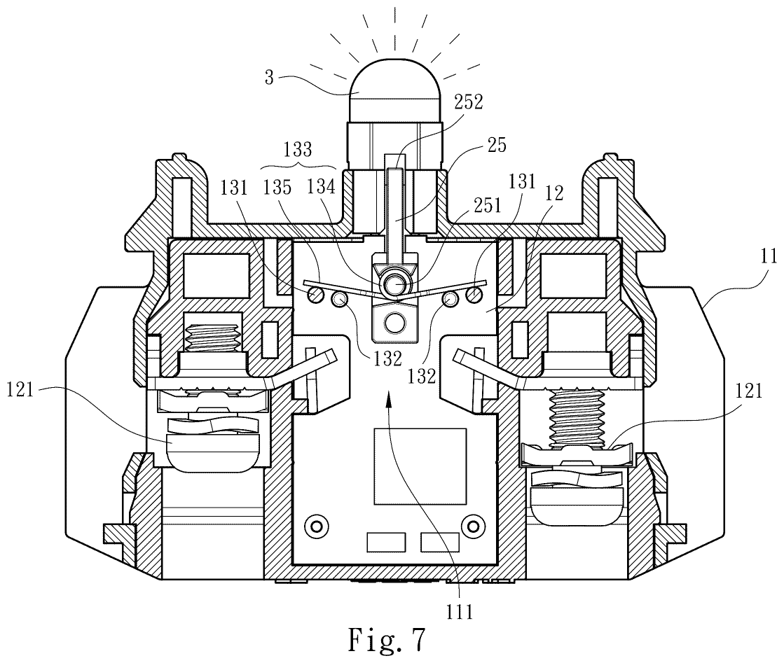

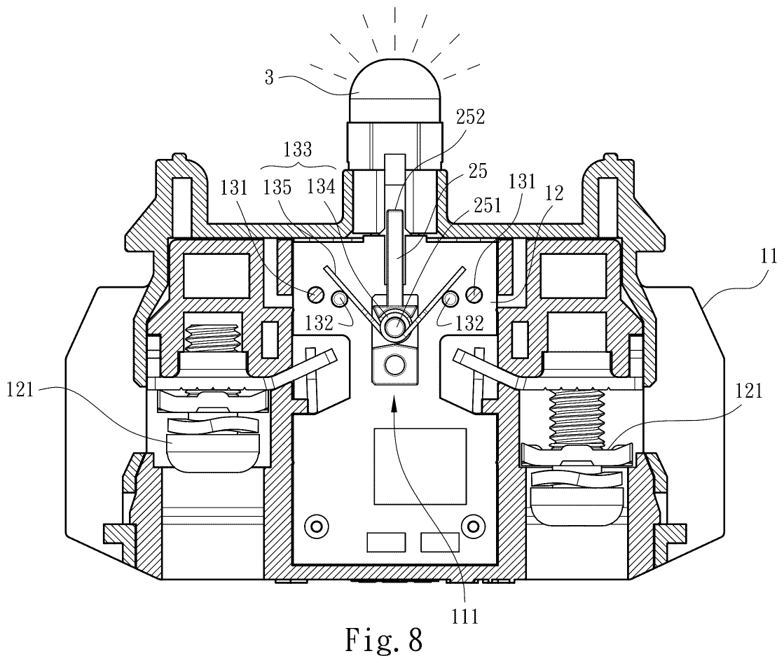

Please refer to FIGS. 7 and 8 for the operation of the first embodiment of the present invention. When the push button 21 is subjected to a force and downward pushed, the actuator 22 is brought by the push button 21 to move downward at the same time to compress the elastic element 23. At this point, the first abutting sections 221 are pressed against the upward protruded section 252 of the link member 25 and the second abutting sections 222 are pressed against the push sections 52 of the normally open contact blocks 5. When the push sections 52 are pressed by the second abutting sections 222, the two control terminals 51 are simultaneously electrically connected. At this point, the link member 25 brings the elastic conducting element 133 to move along the guide slot 122 toward the two conducting sections 132. Since the two conducting arms 135 would first contact with the insulation stop sections 131 to be elastically bent before they contact with both the insulation stop sections 131 and the conducting sections 132, as shown in FIG. 7. At this point, the elastic conducting element 133 is in a bent state and the two conducting arms 135 are in initial or non-stable contact with the two conducting sections 132. When the push button 21 is continuously downward pushed, the two conducting arms 135 of the elastic conducting element 133 are restricted between the two conducting sections 132 to be bent further and finally separate from the two insulation stop sections 131. At this point, the two conducting arms 135 are in stable contact with only the two conducting sections 132, and the two conducting sections 132 become electrically connected via the elastic conducting element 133 to close a circuit between the light source 3 and the external power source, so that the light source 3 is lighted, as shown in FIG. 8.

In the above structure, the two insulation stop sections 131 are located in front of the moving path along which the elastic conducting element 133 is moved toward the conducting sections 132. With this arrangement, it is able to ensure the two conducting arms 135 would not contact with the two conducting sections 132 when the push button 21 is not pushed down and to avoid incorrect conduction. Further, when the push button 21 is downward pushed, the two insulation stop sections 131 can serve as an aid to first turn the two conducting arms 135, so that the two conducting arms 135 can contact with the two conducting sections 132 mildly and smoothly with a somewhat small force to avoid the two conducting sections 132 from bending and deforming due to a sudden strong force applied thereto.

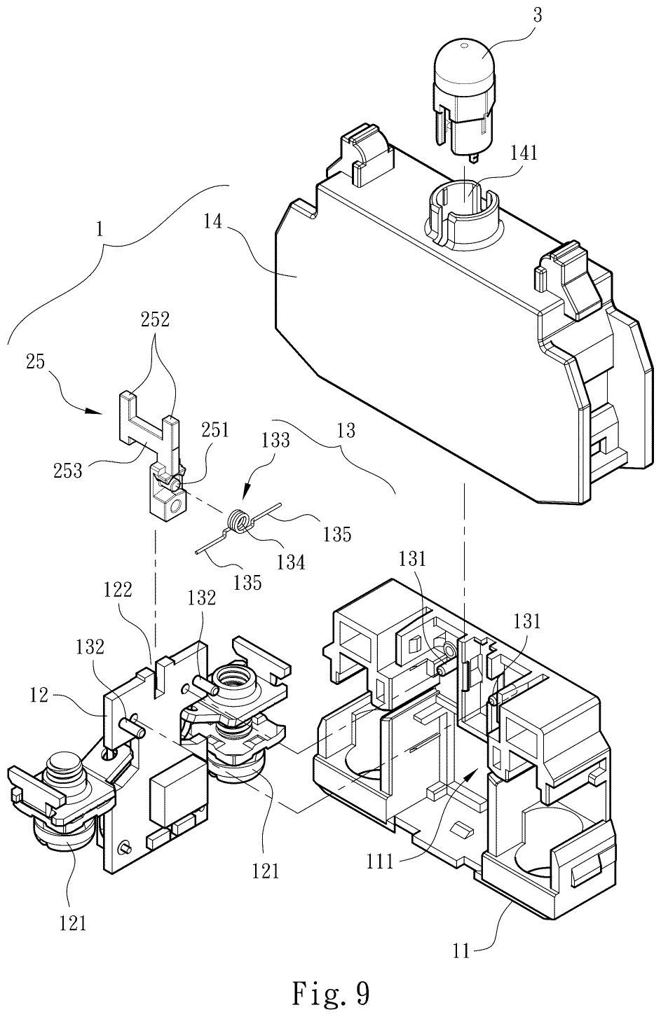

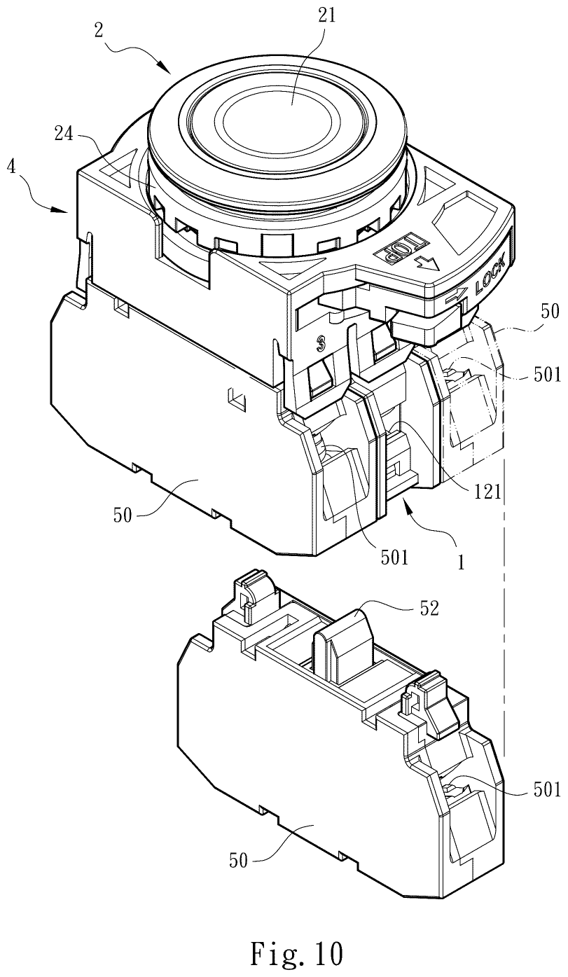

Please refer to FIGS. 9 to 11, in which a normally closed switch structure according to a second embodiment of the present invention is shown. The normally closed switch structure in the second embodiment includes a main body 1, a push button assembly 2, and a coupling seat 4. The push button assembly 2 and the coupling seat 4 are the same as those in the first embodiment. The main body 1 includes an internal switch assembly 13, a base 11, a circuit board 12, and power terminals 121. The base 11, the circuit board 12, and the power terminals 121 are the same as those in the first embodiment.

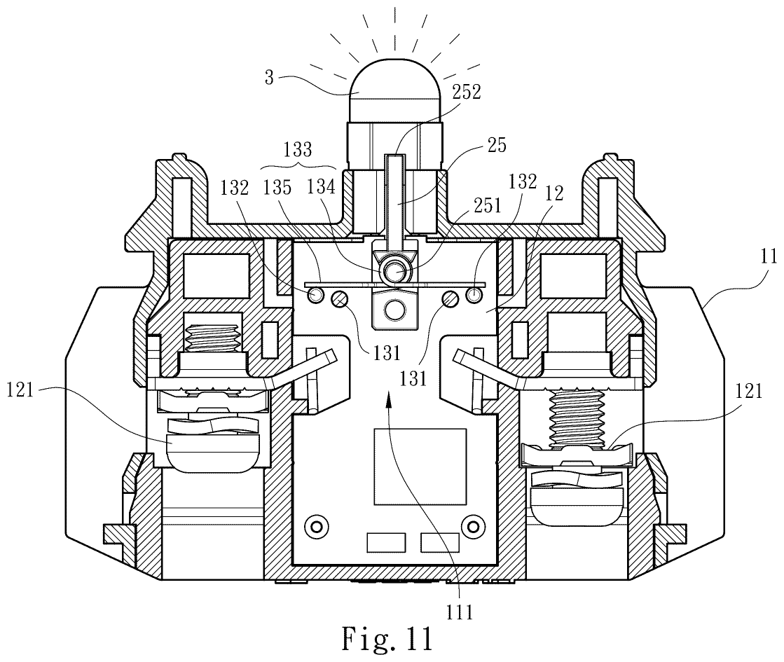

The second embodiment is different from the first one in that the coupling seat 4 is configured for fixedly connecting the main body 1 and at least one normally closed contact blocks 50 in parallel, and each normally closed contact block 50 is provided with a plurality of control terminals 501 for connecting to an external device to be controlled and a push section 52 for controlling the electrical connection or disconnection of the control terminals 501. In the drawings shown the second embodiment, two normally closed contact blocks 50 are shown. The internal switch assembly 13 includes two post-like conducting sections 132 spaced from each other by a fixed distance, two post-like insulation stop sections 131 provided between the two conducting sections 132, which are connected to between the light source 3 and the power terminals 121 in series, and an elastic conducting element 133, such as a torsion spring. The elastic conducting element 133 includes a middle portion formed into a cylindrical coil body 134, which is connected to a link member 25 of the push button assembly 2 to move along with the push button 21, and two elastically bendable conducting arms 135 extended from two lateral sides of the cylindrical coil body 134 toward the two conducting sections 132. The insulation stop sections 131 are located in front of a moving path of the elastic conducting element 133. For example, as shown in FIG. 11, the two insulation stop sections 131 are located between and lower than the two conducting sections 132.

In the second embodiment, when the push button 21 is in a natural state without being pushed downward, the actuator 22 is supported by the elastic element 23 to maintain at a position spaced from the base 11, such that the second abutting sections 222 are not in contact with the push sections 52 of the normally closed contact blocks 50, the control terminals 501 maintain at the closed position, and the first abutting sections 221 are not in contact with the upward protruded section 252 of the link member 25. At this point, the two conducting arms 135 of the elastic conducting element 133 are located at a position in contact with the two conducting sections 132, and the light source 3 is electrically connected to the external power source and lighted, as shown in FIG. 11, indicating the external device being controlled is in a normal operational state.

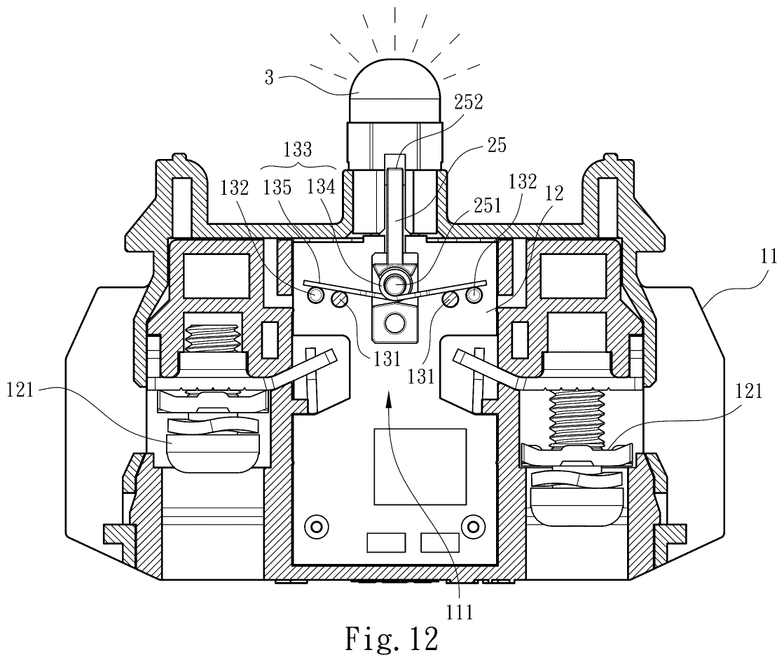

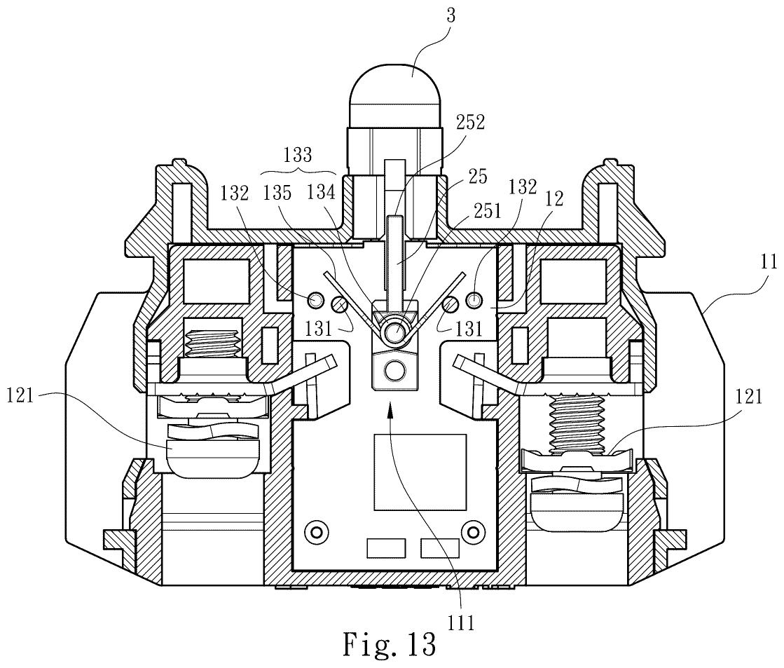

Please refer to FIGS. 12 and 13 for the operation of the second embodiment of the present invention. When the push button 21 is subjected to a force and downward pushed, the actuator 22 is brought by the push button 21 to move downward at the same time to compress the elastic element 23. At this point, the first abutting sections 221 are pressed against the upward protruded section 252 of the link member 25 and the second abutting sections 222 are pressed against the push sections 52 of the normally closed contact blocks 50. When the push sections 52 are pressed by the second abutting sections 222, the two control terminals 501 are electrically disconnected from each other. At this point, the external device electrically connected to the two control terminals 501 is in an open circuit and disabled state. Meanwhile, the link member 25 brings the elastic conducting element 133 to slide along the guide slot 122 toward the two insulation stop sections 131. Since the two conducting arms 135 contact with the two conducting sections 132 first, the two conducting arms 135 are elastically bent to touch the two insulation stop section 131, as shown in FIG. 12. At this point, the elastic conducting element 133 is in an initially bent position, and the two conducting arms 135 are in unstable contact with the two conducting sections 132. When the push button 21 is continuously downward pushed, the two conducting arms 135 of the elastic conducting element 133 are restricted between the two insulation stop sections 131 and bent further to finally separate from the two conducting sections 132 to contact only with the two insulation stop sections 131. At this point, the two conducting sections 132 are electrically disconnected from each other, and the light source 3 is not able to electrically connect to the external power source and accordingly, could not emit light, as shown in FIG. 13.

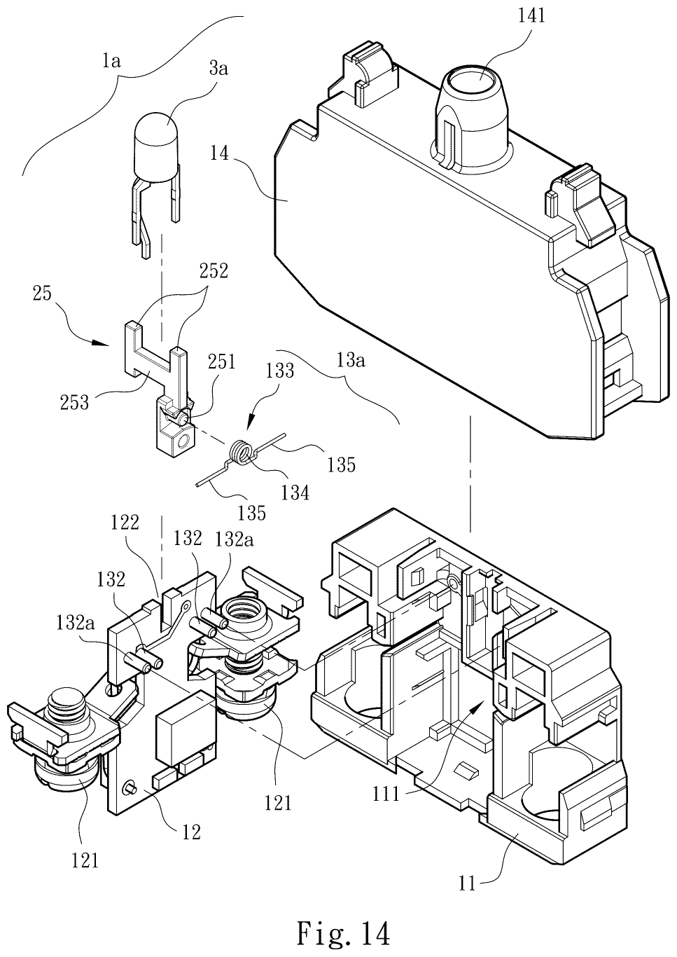

Please refer to FIGS. 14 to 16, in which a switch structure with a multi-color light source according to a third embodiment of the present invention is shown. The switch structure with a multi-color light source includes a main body 1a, a push button assembly 2, and a coupling seat 4. The push button assembly 2 and the coupling seat 4 are the same as those in the first embodiment. The main body 1a includes an internal switch assembly 13a, a base 11, a circuit board 12, and power terminals 121. The base 11, the circuit board 12, and the power terminals 121 are the same as those in the first embodiment.

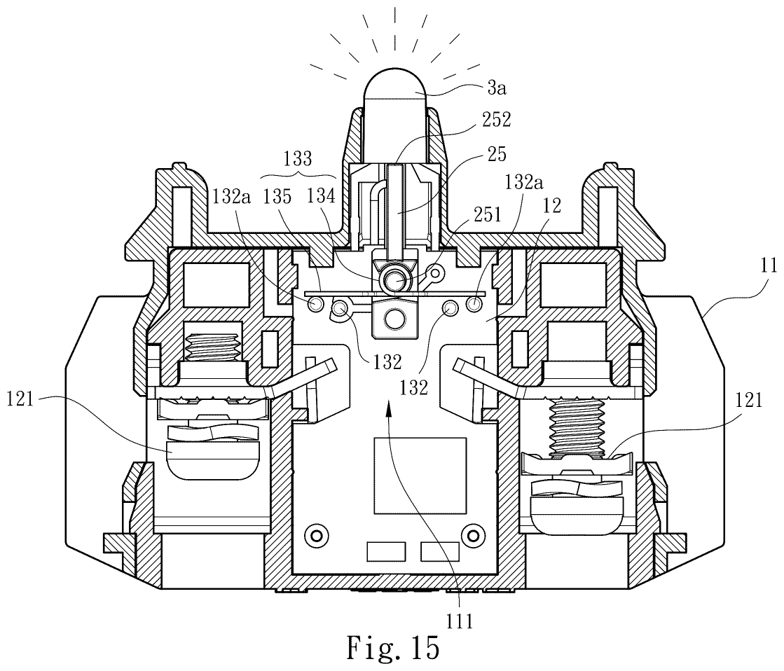

The third embodiment is different from the first one in having a light source 3a, which is a light emitter capable of emitting different color lights. The light source 3a is fixedly fitted in the assembling hole 141 of the cover 14 and includes a plurality of input pins. The internal switch assembly 13a includes two fixedly spaced post-like first conducting sections 132 and two fixedly space post-like second conducting sections 132a. The first conducting sections 132 and the second conducting sections 132a are located in the moving path of the elastic conducting element 133 but at different positions relative to the moving path. For example, as shown in FIG. 15, the two first conducting sections 132 are located at positions between and lower than the two second conducting sections 132a, and the two first conducting sections 132 are serially connected to between the pins corresponding to one color light of the light source 3a and the power terminals 121, while the two second conducting sections 132a are serially connected to between the pins corresponding to another color light of the light source 3a and the power terminals 121.

The elastic conducting element 133, such as a torsion spring, has a middle portion formed into a cylindrical coil body 134 for coupling with and moving along with the link member 25 of the push button assembly 2, and two elastically bendable conducting arms 135 extended from two lateral sides of the cylindrical coil body 134 toward the two conducting sections 132 and the two conducting sections 132a.

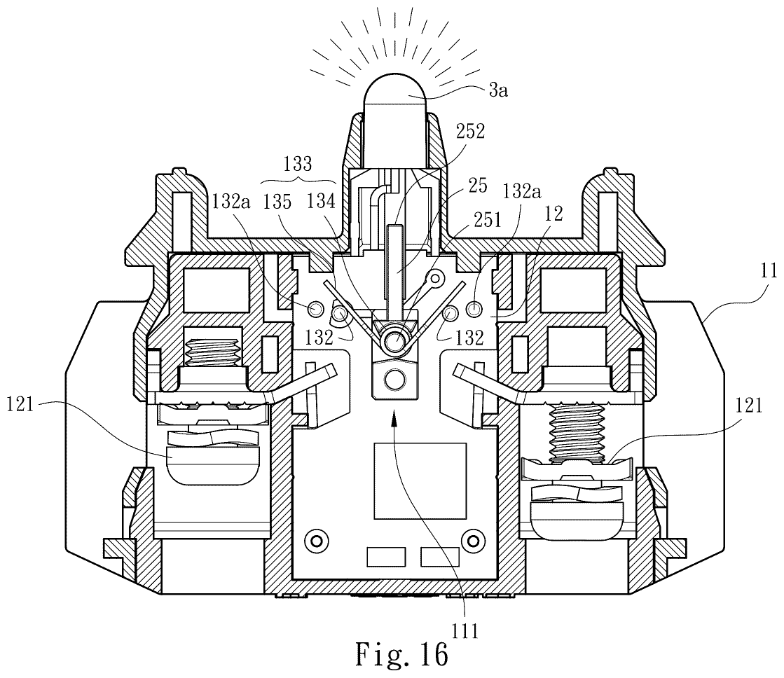

In the third embodiment, when the push button 21 is in a natural state without being downward pushed, the two conducting arms 135 of the elastic conducting element 133 respectively maintain at a straight position to contact with and electrically connect to the two second conducting sections 132a, and the pins of the light source 3a corresponding to one color light, such as red color light, are electrically connected to the external power source, so that the light source 3a emits light, as shown in FIG. 15, indicating the push button assembly 2 and the main body 1a are in a control state to control the external device to perform a specific operation. On the other hand, when the push button 21 is subjected to a force and downward pushed, the two conducting arms 135 of the elastic conducting element 133 are bent to contact with and electrically connect to the two first conducting sections 132 and then separate from the two second conducting sections 132a, and the pins corresponding to another color light of the light source 3a, such as green light, are electrically connected to the external power source, so that the light source 3a emits light, as shown in FIG. 16, indicating the push button assembly 2 and the main body 1a are in a control state to control the external device to perform another specific operation. Therefore, the switch structure according to the third embodiment of the present invention allows for changes in the application thereof.

According to the above discussion, the switch structure electrically linked with a light source according to the present invention has the advantages of having a simplified overall structure, avoiding occupation of the original control contacts of the contact block, and effectively upgrading an overall operational efficiency. Therefore, the present invention meets the requirements of novelty and improvement for granting a patent. It is also understood the present invention has been described with some preferred embodiments thereof and it is understood that many changes and modifications in the described embodiments can be carried out without departing from the scope and the spirit of the invention that is intended to be limited only by the appended claims.

What is claimed is:

1. A switch structure electrically linked with a light source, comprising a main body (1, 1a), a push button assembly (2), and at least one contact block (5, 50); the main body (1, 1a) including a base (11) provided with a plurality of power terminals (121) for connecting to an external power source, and an internal switch assembly (13, 13a) being serially connected to between the power terminals (121) and a light source (3, 3a); the contact block (5, 50) including a plurality of control terminals (50, 501) for connecting to external devices to be controlled; the push button assembly (2) being able to drive the internal switch assembly (13, 13a) and the contact block (5, 50), such that the contact block (5, 50) can change an electrical connection state between the control terminals (51, 501) and the internal switch assembly (13, 13a) can synchronously control an electrical connection state of the light source (3, 3a) to the external power source.

2. The switch structure electrically linked with a light source as claimed in claim 1, wherein the internal switch assembly (13, 13a) includes two fixedly spaced conducting sections (132) and an elastic conducting element (133) located between the two conducting sections (132); the two conducting sections (132) being electrically connected to the power terminals (121) and the light source (3), respectively, and the elastic conducting element (133) being driven by the push button assembly (2) to contact with or separate from the two conducting sections (132), so as to control the light source (3) to electrically connect to or electrically disconnect from the external power source.

3. The switch structure electrically linked with a light source as claimed in claim 2, wherein the push button assembly (2) includes a link member (25) movable by a force, the elastic conducting element (133) being coupled with the link member (25) and including two elastically bendable conducting arms (135) extending toward the two conducting sections (132); the elastic conducting element (133) being movable along with the link member (25) to bring the two conducting arms (135) to contact with or separate from the two conducting sections (132), so as to control the light source (3) to electrically connect to or electrically disconnect from the external power source.

4. The switch structure electrically linked with a light source as claimed in claim 3, wherein the internal switch assembly (13, 13a) further includes two forward projected insulation stop sections (131) located at two lateral outer sides of the two conducting sections (132); the insulation stop sections (131) being located in a moving path of the elastic conducting element (133) at positions close to and ahead of the two conducting sections (132); the contact block (5) being a normally open contact block and including a plurality of normally open control terminals (51) and a push section (52) for controlling an electrical connection state of the control terminals (51).

5. The switch structure electrically linked with a light source as claimed in claim 3, wherein the internal switch assembly (13, 13a) further includes two forward projected insulation stop sections (131) located between the two conducting sections (132); the insulation stop sections (131) being located in a moving path of the elastic conducting element (133) at positions close to and behind the two conducting sections (132); the contact module (50) being a normally closed contact block and including a plurality of normally closed control terminals (501) and a push section (52) for controlling an electrical connection state of the control terminals (501).

6. The switch structure electrically linked with a light source as claimed in claim 4, wherein the base (11) internally defines a receiving space (111) for receiving a circuit board (12) therein; the two conducting sections (132) being provided on the circuit board (12) and the insulation stop sections (131) being provided in the receiving space (111); the base (11) being externally fitted with a cover (14), and the light source (3) being fixedly mounted to an outer surface of the cover (14).

7. The switch structure electrically linked with a light source as claimed in claim 5, wherein the base (11) internally defines a receiving space (111) for receiving a circuit board (12) therein; the two conducting sections (132) being provided on the circuit board (12) and the insulation stop sections (131) being provided in the receiving space (111); the base (11) being externally fitted with a cover (14), and the light source (3) being fixedly mounted to an outer surface of the cover (14).

8. The switch structure electrically linked with a light source as claimed in claim 6, wherein the circuit board (12) is provided with a guide slot (122), and the link member (25) is provided with a sliding guide section (253); and the sliding guide section (253) being extended through into and slidable in the guide slot (122).

9. The switch structure electrically linked with a light source as claimed in claim 1, wherein the light source (3a) is a light emitting body capable of producing different color lights and includes a plurality of input pins; the internal switch assembly (13a) including two fixedly spaced first conducting sections (132), two second conducting sections (132a), and an elastic conducting element (133); the elastic conducting element (133) being located between the two first conducting sections (132) and also between the two second conducting sections (132a), and the first conducting sections (132) and the second conducting sections (132a) being located in the moving path of the elastic conducting element (133) at different positions; the two first conducting sections (132) being electrically connected to the power terminals (121) and a set of input pins corresponding to one color light of the light source (3a), respectively, while the two second conducting sections (132a) being electrically connected to the power terminals (121) and another set of input pins corresponding to another color light of the light source (3a), respectively; and the elastic conducting element (133) being driven by the push button assembly (2) to contact with one of the first conducting sections (132) and the second conducting sections (132a), such that the light source (3a) is able to indicate different control states via different color lights.

10. The switch structure electrically linked with a light source as claimed in claim 3, wherein the push button assembly (2) includes a push button (21) and an actuator (22) electrically connected to each other, and an elastic element (23) being disposed between the actuator (22) and the main body (1); the actuator (22) including first abutting sections (221) and second abutting sections (222) located corresponding to the link member (25) and the contact block (5, 50), respectively; such that the actuator (22) can be brought by the push button (21) to move at the same time with the first abutting sections (221) abutted against the link member (25) and the second abutting sections (222) abutted against the contact block (5, 50).

11. The switch structure electrically linked with a light source as claimed in claim 4, wherein the push button assembly (2) includes a push button (21) and an actuator (22) electrically connected to each other, and an elastic element (23) being disposed between the actuator (22) and the main body (1); the actuator (22) including first abutting sections (221) and second abutting sections (222) located corresponding to the link member (25) and the contact block (5, 50), respectively; such that the actuator (22) can be brought by the push button (21) to move at the same time with the first abutting sections (221) abutted against the link member (25) and the second abutting sections (222) abutted against the contact block (5, 50).

12. The switch structure electrically linked with a light source as claimed in claim 5, wherein the push button assembly (2) includes a push button (21) and an actuator (22) electrically connected to each other, and an elastic element (23) being disposed between the actuator (22) and the main body (1); the actuator (22) including first abutting sections (221) and second abutting sections (222) located corresponding to the link member (25) and the contact block (5, 50), respectively; such that the actuator (22) can be brought by the push button (21) to move at the same time with the first abutting sections (221) abutted against the link member (25) and the second abutting sections (222) abutted against the contact block (5, 50).

13. The switch structure electrically linked with a light source as claimed in claim 9, wherein the push button assembly (2) includes a push button (21) and an actuator (22) connected to each other, a link member movable under a force, and an elastic element (23) disposed between the actuator (22) and the main body (1a); the actuator (22) including first abutting sections (221) and second abutting sections (222) located corresponding to the link member (25) and the contact block (5, 50), respectively, such that the actuator can be brought by the push button (21) to move at the same time with the first abutting sections (221) abutted against the link member (25) and the second abutting sections (222) abutted against the contact block (5, 50); and the elastic conducting element (133) being coupled with the link member (25).

14. The switch structure electrically linked with a light source as claimed in claim 10, wherein the main body (1) and the contact block (5, 50) are assembled to each other via a coupling seat (4), and the coupling seat (4) including a mounting hole (41); the push button assembly (2) including a push button seat (24) for receiving the push button (21) and the actuator (22) therein; and the push button seat (24) being fitted in the mounting hole (41) to connect to the coupling seat (4).

15. The switch structure electrically linked with a light source as claimed in claim 11, wherein the main body (1) and the contact block (5, 50) are assembled to each other via a coupling seat (4), and the coupling seat (4) including a mounting hole (41); the push button assembly (2) including a push button seat (24) for receiving the push button (21) and the actuator (22) therein; and the push button seat (24) being fitted in the mounting hole (41) to connect to the coupling seat (4).

16. The switch structure electrically linked with a light source as claimed in claim 12, wherein the main body (1) and the contact block (5, 50) are assembled to each other via a coupling seat (4), and the coupling seat (4) including a mounting hole (41); the push button assembly (2) including a push button seat (24) for receiving the push button (21) and the actuator (22) therein; and the push button seat (24) being fitted in the mounting hole (41) to connect to the coupling seat (4).

17. The switch structure electrically linked with a light source as claimed in claim 13, wherein the main body (1a) and the contact block (5, 50) are assembled to each other via a coupling seat (4), and the coupling seat (4) including an mounting hole (41); the push button assembly (2) including a push button seat (24) for receiving the push button (21) and the actuator (22) therein; and the push button seat (24) being fitted in the mounting hole (41) to connect to the coupling seat (4).

18. The switch structure electrically linked with a light source as claimed in claim 14, wherein the main body (1) and the contact block (5, 50) respectively have a substantially rectangular configuration, and the contact block (5, 50) is parallelly arranged on at least one lateral side of the main body (1).

19. The switch structure electrically linked with a light source as claimed in claim 15, wherein the main body (1) and the contact block (5, 50) respectively have a substantially rectangular configuration, and the contact block (5, 50) is parallelly arranged on at least one lateral side of the main body (1).

20. The switch structure electrically linked with a light source as claimed in claim 17, wherein the main body (1a) and the contact block (5, 50) respectively have a substantially rectangular configuration, and the contact block (5, 50) is parallelly arranged on at least one lateral side of the main body (1a).
